(19) United States
(12) Patent Application Publication
(10) Pub. No.: US 2004/0267525 A1
(43) Pub. Date: Dec. 30, 2004

(54) Apparatus for and method of determining transmission rate in speech transcoding

(76) Inventors: Eung Don Lee, Daejeon-city (KR); Hyun Woo Kim, Seoul (KR); Do Young Kim, Daejeon-city (KR); Chang Dong Yoo, Deajeon-city (KR); Seong Ho Seo, Daegu-city (KR); Dal Won Jang, Kyungsangnam-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/729,058

(22) Filed: Dec. 4, 2003

(30) Foreign Application Priority Data
Jun. 30, 2003 (KR) 2003-43374

(51) Int. Cl. G10L 11/06

(52) U.S. Cl. 704/208

(57) ABSTRACT

Provided are an apparatus for and a method of determining a transmission rate in speech transcoding. An input frame is classified as speech or silence based on a first threshold value that is predetermined for at least one of a fixed code-book gain value, an adaptive code-book gain value, a noise to signal rate, and a pitch delay that correspond to an input parameter of a coded bit stream. An input frame classified as voiced is classified as stationary or non-stationary based on a third threshold value that is predetermined for the amount of change in the ACBG value or a difference between the minimum and maximum pitch delays. An input frame, classified as voiced by a voiced/unvoiced classifying portion, is classified as voiced or non-stationary based on a class of a previous frame. An input frame, classified as voiced by a voiced/non-stationary classifying portion, is classified as stationary or non-stationary based on a third threshold value that is predetermined for the amount of change in the ACBG value or a difference between the minimum and maximum pitch delays. A transmission rate and a type of the determined rate for the input frame are determined based on transmission rates and types of the transmission rates that are predetermined for a class of the input frame corresponding to the result of classification.

### CROSS REFERENCE TO RELATED APPLICATION

This application claims the priority of Korean Patent Application No. 2003-43374, filed on Jun. 30, 2003, in the Korean Intellectual Property Office, the disclosure of which is hereby incorporated by reference in its entirety.

### BACKGROUND OF THE INVENTION

1. Field of the Invention

The present invention relates to an apparatus for and a method of determining a transmission rate in speed transcoding, and more particularly, to an apparatus for and a method of determining a transmission rate when a signal encoded by a Code-Excited Linear Prediction (CELP)-based vocoder is transcoded into a signal available for a Selected Mode Vocoder (SMV).

2. Description of the Related Art

Speech transcoding involves converting a bit stream coded by a speech coder into a bit stream available for another speech coder. A speech transcoder can be realized by directly connecting a decoder of speech codec with a coder of another speech codec. However, this direct connection has such problems that a delay time introduced by transcoding increases and a large amount of computation is required. To solve such problems, a transcoder that directly converts speech at a parameter level without completely decoding the speech has been developed for transcoding between the decoder and the coder.

At present, a variety of speech coders are used after being standardized for different communication environments. In a Code Division Multiple Access (CDMA) technique, an SMV is used as a standardized speech coder. The SMV determines a transmission rate for each frame to save bandwidth. The SMV has four transmission rates of 8.55 Kbps, 4.0 Kbps. 2.0 Kbps, and 0.8 Kbps and performs coding after determining a transmission rate for each frame. These four transmission rates are called Rate 1 (full-rate), Rate 2 (half-rate), Rate ¼ (quarter-rate), and Rate ⅛ (eighth-rate). Rate 1 and Rate ½ each have two types, i.e., type 0 and type 1. If a frame is stationary-voiced, it corresponds to type 1. In other cases, the frame corresponds to type 0. To determine the transmission rate for each frame and the type of the determined transmission rate, the SMV classifies an input as one of a total of 6 frame classes. This process is called frame classification. Such 6 frame classes consist of silence, noise-like, unvoiced, onset, non-stationary voiced, and stationary voiced.

FIG. 1 is a flowchart describing the procedures for determining a transmission rate in a conventional SMV.

Referring to FIG. 1, pre-processing is performed on a speech signal input to the SMV in step S100. A linear prediction coefficient (LPC) is obtained from the pre-processed speech signal in step S110, and perceptual weighting filtering is performed on the pre-processed speech signal and the LPC obtained in step S120. In step S130, voice activity detection is performed using the LPC obtained in step S110.

In step S140, music detection is performed using the LPC obtained in step S110 and the detected voice activity. In step S150, the levels of voiced/unvoiced are determined based on the LPC on which perceptual weighting filtering is performed. In step S160, open-loop pitch detection is performed using the LPC obtained in step S110 and the LPC on which perpetual weighting filtering is performed. In step S170, a frame class is decided by comparing the detected open-loop pitch, the determined levels of voiced/unvoiced, the result of music detection, the result of voice activity detection, and the LPC obtained in step S110 with predefined threshold values, and a transmission rate corresponding to the decided frame class is determined. Table 1 shows transmission rates corresponding to frame classes.

TABLE 1

| Mode | Frame class | Rate ⅛ | Rate ¼ | Rate ½ | Rate 1 |
|---|---|---|---|---|---|
| 0 | Silence | ✓ | | | |
| | Noise-like | | | ✓ | ✓ |
| | unvoiced | | | ✓ | ✓ |
| | onset | | | ✓ | ✓ |
| | Non-stationary | | | | ✓ |
| | voiced | | | | |
| | Stationary voiced | | | | ✓ |
| 1, 2, 3 | Silence | ✓ | | | |
| | Noise-like | | ✓ | ✓ | |
| | unvoiced | | ✓ | ✓ | |
| | onset | | ✓ | ✓ | ✓ |
| | Non-stationary | | | ✓ | ✓ |
| | voiced | | | | |
| | Stationary voiced | | | ✓ | ✓ |

When such procedures for determining a transmission rate in the SMV are applied to a transcoder, the following problems may occur.

First, an algorithm for determining a transmission rate in the SMV determines the transmission rate based on various speech parameters obtained from input speech. However, in general, a signal input to the transcoder is not speech but a bit stream.

Second, as shown in FIG. 1, the procedures for determining a transmission rate in the SMV need to include LP analysis and open-loop pitch detection that are not required in the transcoder. As a result, the procedures for determining a transmission rate in the SMV are applicable to the transcoder, but these procedures make the transcoding process inefficient.

### SUMMARY OF THE INVENTION

The present invention provides an apparatus for and a method of determining a transmission rate based on parameters of an input bit stream, in a transcoder that transcodes a signal encoded by a Code-Excited Linear Prediction (CELP)-based vocoder into a signal available for an SMV.

The present invention also provides a computer readable recording medium having recorded thereon a program for a method of determining a transmission rate based on parameters of an input bit stream, in a transcoder that transcodes a signal encoded by a Code-Excited Linear Prediction (CELP)-based vocoder into a signal available for an SMV.

According to an aspect of the present invention, there is provided an apparatus for determining transmission rate in speech transcoding comprising: a speech/silence classifying portion, which classifies an input frame as speech or silence, based on a first threshold value that is predetermined for at least one of a fixed code-book gain value, an adaptive code-book gain value, a noise to signal rate, and a pitch delay that correspond to an input parameter of a coded bit stream; a voiced/unvoiced classifying portion, which classifies as voiced or unvoiced an input frame that is classified as speech, based on a second threshold value that is predetermined for the adaptive code-book gain value; a voiced/non-stationary classifying portion, which classifies as voiced or non-stationary an input frame that is classified as voiced by the voiced/unvoiced classifying portion, based on a class of a previous frame; a voiced classifying portion, which classifies as stationary or non-stationary an input frame that is classified as voiced by the voiced/non-stationary classifying portion, based on a third threshold value that is predetermined for the amount of change in the ACBG value or a difference between the maximum value and the minimum value of the pitch delay; and a transmission rate determining portion, which determines a transmission rate and a type of the determined transmission rate for an input frame, based on transmission rates and types of the transmission rates that are predetermined for a class of the input frame corresponding to the result of classification.

According to another aspect of the present invention, there is provided a method of determining transmission rate in speech transcoding comprising: (a) classifying an input frame as speech or silence based on a first threshold value that is predetermined for at least one of a fixed code-book gain value, an adaptive code-book gain value, a noise to signal rate, and a pitch delay that correspond to an input parameter of a coded bit stream; (b) classifying as voiced or unvoiced an input parameter that is classified as speech, based on a third threshold value that is predetermined for the amount of change in the ACBG value or a difference between the maximum value and the minimum value of the pitch delay; (c) classifying as voiced or non-stationary an input frame that is classified as voiced, based on a class of a previous frame; (d) classifying as stationary or non-stationary an input frame that is classified as voiced, based on a third threshold value that is predetermined for the amount of change in the ACBG value or a difference between the maximum value and the minimum value of the pitch delay; and (e) determining a transmission rate and a type of the determined transmission rate for an input frame, based on transmission rates and types of the transmission rates that are predetermined for a class of the input frame corresponding to the result of classification.

Thus, it is possible to easily classify a frame, simply implement the procedures for determining a transmission rate, and reduce the amount of computation.

### BRIEF DESCRIPTION OF THE DRAWINGS

The above and other aspects and advantages of the present invention will become more apparent by describing in detail an exemplary embodiment thereof with reference to the attached drawings in which:

FIG. 1 is a flowchart describing the procedures for determining a transmission rate in a conventional SMV;

FIG. 2 is a block diagram of an apparatus for determining a transmission rate in speech transcoding, according to the present invention;

FIG. 3 shows a difference between minimum and maximum pitch delays of a G.729 Annex A (G.729A)-compliant signal input during inputs of two frames and speech signals of the frames;

FIG. 4 shows a minimum adaptive code-book gain (ACGB) value for each frame;

FIG. 5 shows G. 729A-compliant FCBG values of a clean signal and a single speech signal that is mixed with a white noise signal; and

FIG. 6 is a flowchart describing a method of determining a transmission rate in speech transcoding, according to the present invention.

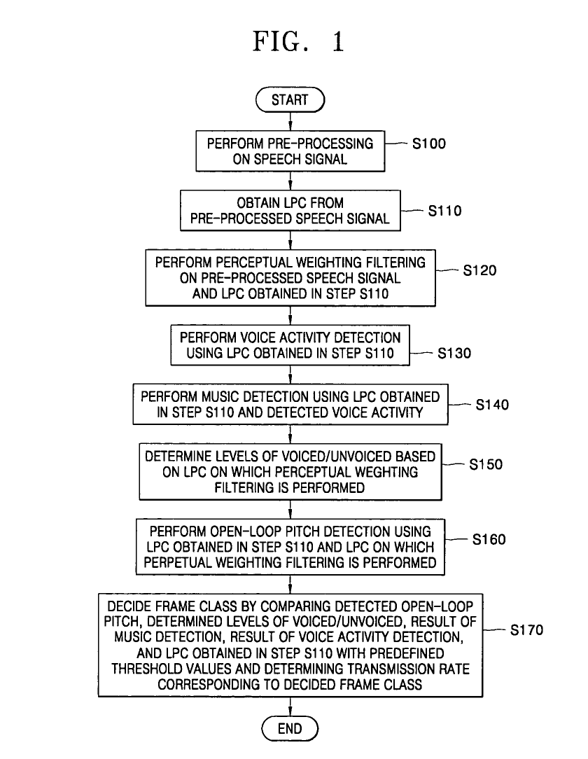

### DETAILED DESCRIPTION OF THE INVENTION

The present invention will now be described more fully with reference to the accompanying drawings, in which a preferred embodiment of the invention is shown. In the drawings, like reference numerals are used to refer to like elements throughout.

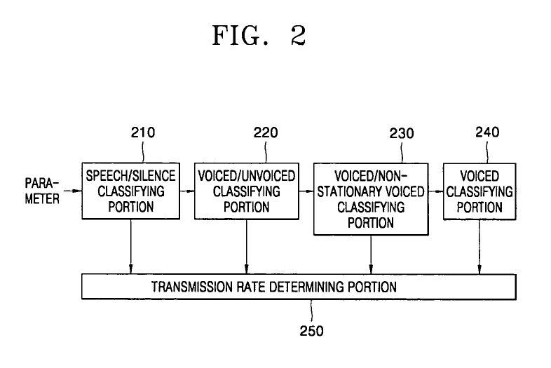

FIG. 2 is a block diagram of an apparatus for determining a transmission rate in speech transcoding, according to the present invention. Conventional SMVs classify each frame into one of a total of 6 frame classes, so as to determine a transmission rate for each frame. For the simplicity of frame classification, the apparatus for determining a transmission rate in speech transcoding according to the present invention groups noise-like and unvoiced into unvoiced and classifies each frame as one of a total of 5 frame classes. Also, the apparatus for determining a transmission rate in speech transcoding, shown in FIG. 2, determines a transmission rate when a G.729A-compliant signal is transcoded into a signal available for an SMV. The standard for frame classification may vary from codec to codec. Hereinafter, a case where the G.729A-compliant signal is transcoded into the signal available for the SMV will be described.

Referring to FIG. 2, the apparatus for determining a transmission rate in speech transcoding according to the present invention includes a speech/silence classifying portion 210, a voiced/unvoiced classifying portion 220, a voiced/non-stationary voiced classifying portion 230, a voiced classifying portion 240, and a transmission rate determining portion 250.

The speech/silence classifying portion 210 classifies as speech or silence an input frame, based on a FCBG value, an ACBG value, a noise to signal rate (NSR), and a pitch delay that correspond to an input frame of an input parameter of a coded bit stream. At this time, if the FCBG value and the ACBG value for the input bit stream are more than a predefined first threshold value and the NSR and the pitch delay are less than a predefined second threshold value, the speech/silence classifying portion 210 classifies the input frame corresponding to the input bit stream as speech.

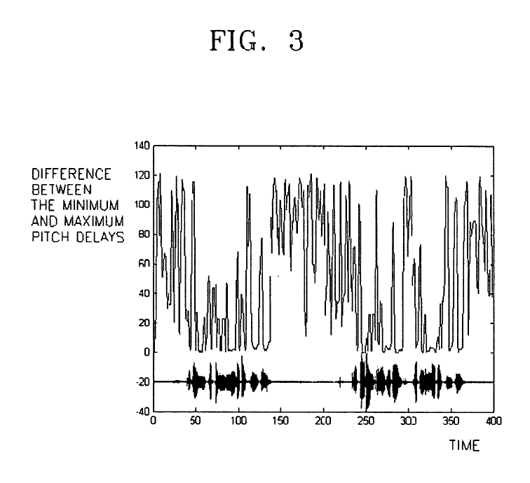

The pitch delay of the G.729A-compliant signal drastically changes during a no-speech period. By using this characteristic, it is possible to distinguish between a speech period and the no-speech period. FIG. 3 shows the difference between the minimum and maximum pitch delays of the G.729A-compliant signal that is input during inputs of two frames and speech signals of the frames. Referring to FIG. 3, the difference between the minimum and maximum pitch delays of the G.729A-compliant signal is very small during the presence of speech, but it is very large during the absence of speech. The voice/silence classifying portion 210 distinguishes between the speech period and a silence period, using these characteristics of the pitch delay.

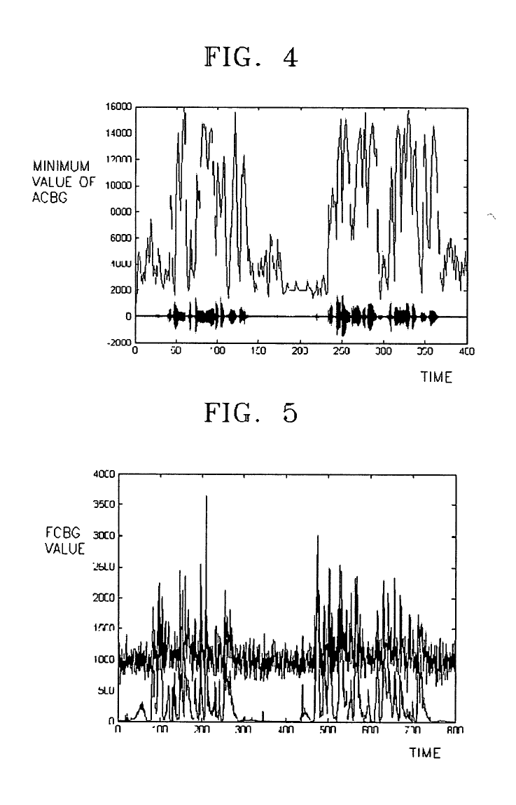

Although the ACBG value changes drastically, when using only the minimum ACBG value within a frame, it is possible to distinguish the speech period and the silence period. FIG. 4 shows the minimum ACBG value for each frame. Referring to FIG. 4, the minimum ACBG value for each frame is large during the presence of speech, but it is small during the absence of speech. Thus, the speech/silence classifying portion 210 can distinguish between the speech period and the silence period based on a predefined threshold value of the minimum ACBG value for each frame.

Generally, in speech coders, the FCBG value has a pattern that is the most similar to that of speech. By using such an FCBG value, speech can be classified into the speech period and the silence period. In other words, a threshold value of the FCBG value is predefined and speech and silence are distinguished based on the predefined threshold value. However, if noise is present in a speech input, classification into speech and silence using the FCBG value does not provide a satisfactory result. FIG. 5 shows G. 729A-compliant FCBG values of a clean signal and a single speech signal that is mixed with a white noise signal. Referring to FIG. 5, the lower-side graph of FIG. 5 indicates the FCBG value of the clean signal that is not mixed with the white noise signal, and the upper-side graph of FIG. 5 indicates the FCBG value of the signal that is mixed with the white noise signal. According to FIG. 5, when the white noise signal is mixed, the amount of noise is large. As a result, it can be seen that it is difficult to set the standards for frame classification into the speech period and the silence period. As such, when noise is mixed, it is not desirable to classify speech into the speech period and the silence period using the FCBG value. Therefore, the FCBG value is used to classify speech the speech period and the silence period, only when the NSR is very small, i.e., only in a frame that is determined not to be mixed with noise. When the NSR is very large, a frame is mixed with much noise, and thus, is determined to be the silence period.

The voice/unvoiced classifying portion 220 classifies as voiced or unvoiced an input frame that is classified as speech, based on the ACBG value. When the ACBG value for an input bit stream that is classified as speech by the speech/silence classifying portion 210 is larger than a predefined threshold value, a frame corresponding to the input bit stream is classified as non-stationary or voiced. When the ACGB value for the input bit stream is smaller than the predefined threshold value, the frame corresponding to the input bit stream is classified as unvoiced class. In other words, the voiced/unvoiced classifying portion 220 classifies a frame as voiced or unvoiced using a threshold value for the minimum ACBG value for each frame which is larger than that of FIG. 4 which is used to classify a frame as speech or silence. Here, theses threshold values are available for various speeches and serve for satisfactory speech classification even when noise is mixed.

The voiced/non-stationary classifying portion 230 classifies as voiced or non-stationary an input frame that is classified as non-stationary or voiced by the voiced/unvoiced classifying portion 220, based on the class of the previous frame. When the class of the previous frame and the class of a current frame corresponding to the input bit stream that is recognized as non-stationary or voiced are identical, the voiced/non-stationary classifying portion 230 classifies the input frame as voiced. When the class of the previous frame and the class of the current frame are different, the voiced/non-stationary classifying portion 230 classifies the input frame as non-stationary.

The voiced classifying portion 240 classifies as stationary or non-stationary an input frame that is classified as voiced by the voiced/non-stationary classifying portion 230, based on the ACBG value and the pitch delay. When using the ACBG value, the voiced classifying portion 240 recognizes whether the whole ACBG values in the input frame are stationary and classifies voiced as stationary and non-stationary. When using the pitch delay, the voiced classifying portion 240 classifies voiced as stationary or non-stationary based on the fact that the whole pitch delays are stationary when the difference between the minimum and maximum pitch delays is small.

The transmission rate determining portion 250 determines a transmission rate and the type of the determined transmission rate for the input frame that is classified by the classifying portions 210 through 240. At this time, the transmission rate determining portion 250 determines a transmission rate and the type of the determined transmission rate for each frame, according to modes specified in Table 2. The transmission rate determining portion 250 uses different threshold values for modes 1, 2, and 3 when classifying each frame. In the present invention, noise-like and unvoiced are classified ad unvoiced for the simplicity of classification.

TABLE 2

| Mode | Frame class | Rate ⅛ | Rate ¼ | Rate ½ | Rate 1 |
|---|---|---|---|---|---|
| 0 | Silence, Noise-like | ✓ | | ✓ | ✓ |
| | unvoiced | | | ✓ | ✓ |
| | onset | | | ✓ | ✓ |
| | Non-stationary | | | | ✓ |
| | voiced | | | | |
| | Stationary voiced | | | | ✓ |
| 1, 2, 3 | Silence, Noise-like | ✓ | ✓ | ✓ | |
| | unvoiced | | ✓ | ✓ | |
| | onset | | ✓ | ✓ | ✓ |
| | Non-stationary | | | ✓ | ✓ |
| | voiced | | | | |
| | Stationary voiced | | | ✓ | ✓ |

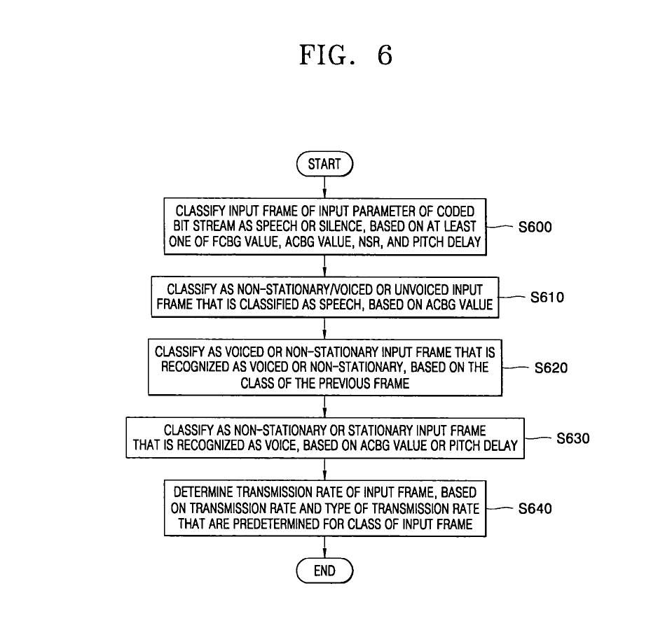

FIG. 6 is a flowchart describing a method of determining a transmission rate in speech transcoding, according to the present invention.

Referring to FIG. 6, the speech/silence classifying portion 210 classifies the input frame of the input parameter of the coded bit stream as speech or silence, based on at least one of the FCBG value, the ACBG value, the NSR, and the pitch delay, in step S600. In step 610, the voiced/unvoiced classifying portion 220 classifies as non-stationary/voiced or unvoiced the input frame that is recognized as speech, based on the ACBG value. In step S620, the voiced/non-stationary voiced classifying portion 230 classifies as voiced or non-stationary the input frame that is recognized as non-stationary or voiced, based on the class of the previous frame. In step S630, the voiced classifying portion 240 classifies as non-stationary or stationary the input frame that is recognized as voiced, based on the ACBG value or the pitch delay. In step S640, the transmission rate determining portion 250 determines a transmission rate and the type of the determined transmission rate for the input frame, based on transmission rates and the types of the transmission rates which are predetermined for the class of the input frame.

According to the apparatus for and the method of determining a transmission rate in speech transcoding, when a signal encoded by a CELP-based vocoder is transcoded into a signal available for an SMV, it is possible to easily classify an input frame, simply implement the procedures for determining a transmission rate, and reduce the amount of computation, using an input parameter of a bit stream.

The present invention may be embodied in a computer readable recording medium by using a computer readable code. The computer readable recording medium includes all sorts of recording devices in which data readable by computer devices is stored. The computer readable recording medium includes, but not limited to, storage media such as ROM, RAM, CD-ROM, magnetic tapes, floppy disks, optical data storage devices, and carrier waves (e.g., transmissions over the Internet). Also, the computer readable recording medium may be distributed over a computer system connected through a network. The computer readable code can be stored and implemented in the computer readable recording medium.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

What is claimed is:

1. An apparatus for determining a transmission rate, the apparatus comprising:
a speech/silence classifying portion, which classifies an input frame as speech or silence, based on a first threshold value that is predetermined for at least one of a fixed code-book gain value, an adaptive code-book gain value, a noise to signal rate, and a pitch delay that correspond to an input parameter of a coded bit stream;
a voiced/unvoiced classifying portion, which classifies as voiced or unvoiced an input frame that is classified as speech, based on a second threshold value that is predetermined for the adaptive code-book gain value;
a voiced/non-stationary classifying portion, which classifies as voiced or non-stationary an input frame that is classified as voiced by the voiced/unvoiced classifying portion, based on a class of a previous frame;
a voiced classifying portion, which classifies as stationary or non-stationary an input frame that is classified as voiced by the voiced/non-stationary classifying portion, based on a third threshold value that is predetermined for the amount of change in the ACBG value or a difference between the maximum value and the minimum value of the pitch delay; and
a transmission rate determining portion, which determines a transmission rate and a type of the determined transmission rate for an input frame, based on transmission rates and types of the transmission rates that are predetermined for a class of the input frame corresponding to the result of classification.

2. A method of determining a transmission rate in speech transcoding, the method comprising:
(a) classifying an input frame as speech or silence based on a first threshold value that is predetermined for at least one of a fixed code-book gain value, an adaptive code-book gain value, a noise to signal rate, and a pitch delay that correspond to an input parameter of a coded bit stream;
(b) classifying as voiced or unvoiced an input parameter that is classified as speech, based on a third threshold value that is predetermined for the amount of change in the ACBG value or a difference between the maximum value and the minimum value of the pitch delay;
(c) classifying as voiced or non-stationary an input frame that is classified as voiced, based on a class of a previous frame;
(d) classifying as stationary or non-stationary an input frame that is classified as voiced, based on a third threshold value that is predetermined for the amount of change in the ACBG value or a difference between the maximum value and the minimum value of the pitch delay; and
(e) determining a transmission rate and a type of the determined transmission rate for an input frame, based on transmission rates and types of the transmission rates that are predetermined for a class of the input frame corresponding to the result of classification.

3. The method of claim 2, wherein in step (a), the input frame is classified as speech or silence based on the first threshold value that is predetermined for the adaptive code-book gain value corresponding to the input parameter.

4. The method of claim 3, wherein the first threshold value is set to be smaller than the second threshold value.

5. The method of claim 2, wherein in step (a), the input frame is classified as speech or silence based on a fourth threshold value that is predetermined for the difference between the maximum value and the minimum value of the pitch delay.

6. The method of claim 5, wherein the fourth threshold value is set to be larger than the third threshold value.

7. The method of claim 2, wherein in step (a), the input frame is classified as speech or silence based on a fifth threshold value that is predetermined for the fixed code-book gain value.

8. The method of claim 7, wherein the NSR for the input frame is smaller than a sixth threshold value.

9. A computer readable recording medium having recorded thereon a program for a method of determining a transmission rate in speech transcoding, the method comprising:
(a) classifying an input frame as speech or silence using a first threshold value that is predetermined for at least one of a fixed code-book gain value, an adaptive code-book gain value, a noise to signal rate, and a pitch delay that correspond to an input parameter of a coded bit stream;
(b) classifying as voiced or unvoiced an input parameter that is classified as speech, based on a third threshold value that is predetermined for the amount of change in the ACBG value or a difference between the maximum value and the minimum value of the pitch delay;
(c) classifying as voiced or non-stationary an input frame that is classified as voiced, based on a class of a previous frame;
(d) classifying as stationary or non-stationary an input frame that is classified as voiced, based on a third threshold value that is predetermined for the amount of change in the ACBG value or a difference between the maximum value and the minimum value of the pitch delay; and
(e) determining a transmission rate and a type of the determined transmission rate for an input frame, based on transmission rates and types of the transmission rates that are predetermined for a class of the input frame corresponding to the result of classification.
